(19) United States
(12) Patent Application Publication
(10) Pub. No.: US 2026/0003195 A1
(43) Pub. Date: Jan. 1, 2026

(54) VARIABLE CURVATURE REFLECTIVE LENS FOR HEAD-MOUNTED DEVICE

(71) Applicant: Universal City Studios LLC, Universal City, CA (US)

(72) Inventors: Benjamin Thompson, Orlando, FL (US); Erin Carter, Orlando, FL (US); Patrick John Goergen, Orlando, FL (US); Thomas Owen Williams, Orlando, FL (US)

(21) Appl. No.: 19/248,081

(22) Filed: Jun. 24, 2025

Related U.S. Application Data
(60) Provisional application No. 63/664,457, filed on Jun. 26, 2024.

(51) Int. Cl. G02B 27/01; G02B 27/12; G06F 3/01

(52) U.S. Cl. CPC G02B 27/0172; G02B 27/123; G06F 3/011; G02B 2027/013

(57) ABSTRACT

In an embodiment, a system includes a head-mounted device including a display configured to display one or more images and a reflective lens spaced apart from the display. The reflective lens is configured to reflect the one or more images towards a user. The reflective lens includes a curved surface having a fixed curve in a vertical plane and a variable curve in a horizontal plane. The system also includes a ride vehicle configured to move along a path. The system also includes a controller communicatively coupled to the head-mounted device and the ride vehicle. The controller is configured to determine a location of the ride vehicle along the path and instruct the display to display the one or more images based on the location of the ride vehicle.

### CROSS-REFERENCE TO RELATED APPLICATION

This application claims priority from and the benefit of U.S. Provisional Patent Application No. 63/664,457, entitled “VARIABLE CURVATURE REFLECTIVE LENS FOR HEAD-MOUNTED DEVICE”, filed Jun. 26, 2024, which is hereby incorporated by reference in its entirety for all purposes.

### BACKGROUND

This section is intended to introduce the reader to various aspects of art that may be related to various aspects of the present disclosure. This discussion is believed to be helpful in providing the reader with background information to facilitate a better understanding of the various aspects of the present disclosure. Accordingly, it should be noted that these statements are to be read in this light and not as admissions of prior art.

The subject matter disclosed herein relates to amusement park attractions and, more specifically, to providing augmented or virtual experiences in amusement park attractions.

Amusement parks or theme parks may include various entertainment attractions useful in providing enjoyment to guests of the amusement parks. For example, the attractions may include a ride attraction (e.g., closed-loop track, dark ride, thriller ride, or other similar ride), and the attraction may be part of a themed environment that may be traditionally established using equipment, furniture, building layouts, props, decorations, displayed media, and so forth. These themed environments can also incorporate augmented reality (AR) systems. Such AR systems may include head-mounted devices (HMDs).

### BRIEF DESCRIPTION

Certain embodiments commensurate in scope with the originally claimed subject matter are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below.

The present embodiments relate to a progressive spherical reflective lens for use on a head-mounted device in an AR environment that enables a wide field of view without creating harsh screen edges or needing to place the lens too close to a user's face. It should be noted that, although the present embodiments are related to a lens for use on a head-mounted device, the reflective lens described herein may be used in other contexts. For example, the lens may be mounted to a ride vehicle, an object in a themed environment, or a land interactive.

In accordance with an embodiment, a head-mounted device includes a display configured to display one or more images, and a reflective lens spaced apart from the display. The reflective lens is configured to reflect the one or more images towards a user. The reflective lens includes a curved surface having a fixed curve in a vertical plane and a variable curve in a horizontal plane.

In an embodiment, a head-mounted device method includes steps of generating, at a server, one or more images of an AR environment, and transmitting, at the server, the one or more images to a head-mounted device. The head-mounted device includes a display configured to display the one or more images, and a reflective lens spaced apart from the display and configured to reflect the one or more images towards the user. The reflective lens includes a curved surface having a fixed curve in a vertical plane and a variable curve in a horizontal plane.

In an embodiment, a system includes a head-mounted device including a display configured to display one or more images, and a reflective lens spaced apart from the display. The reflective lens is configured to reflect the one or more images towards a user. The reflective lens includes a curved surface having a fixed curve in a vertical plane, and a variable curve in a horizontal plane. The system also includes a ride vehicle configured to move along a path. The system also includes a controller communicatively coupled to the head-mounted device and the ride vehicle. The controller is configured to determine a location of the ride vehicle along the path and instruct the display to display the one or more images based on the location of the ride vehicle.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic illustration of an embodiment of a system of an amusement park ride, in accordance with present techniques;

FIG. 2 is a schematic illustration of a head-mounted device, in accordance with present techniques;

FIG. 3 is a schematic illustration of a reflective lens, in accordance with present techniques;

FIG. 4 is a schematic illustration of a variable curve in a horizontal plane of the reflective lens of FIG. 3, in accordance with present techniques;

FIG. 5 is a schematic illustration of a fixed curve of the reflective lens of FIG. 3, in accordance with present techniques;

FIG. 6 is a block diagram of communication between a controller and the head-mounted device, in accordance with present techniques; and

FIG. 7 is a flowchart of a head-mounted device method, in accordance with present techniques.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

An amusement park may include an augmented reality (AR) system to enhance a guest experience of an amusement park attraction by providing guests with AR experiences. For example, the AR system may include a head-mounted device (e.g., electronic goggles or displays, eyeglasses), which may be worn by a guest to enable the guest to view augmented reality features (e.g. virtual objects). In particular, the head-mounted device may be utilized to enhance a guest experience by overlaying virtual objects onto a real-world environment of the amusement park, by providing adjustable virtual environments to provide different experiences in an attraction, and so forth.

Providing an immersive AR experience can be challenging. For example, overlaid AR images are more realistic when these images remain fixed relative to coordinates of the environment, even when the guest turns or moves. Thus, the location of a ride vehicle on the ride path and/or shifts in guest position can be provided as input to the system, and the display characteristics of the AR images can be based on, at least in part, these shifts in position or location. However, existing head-mounted devices do not provide sufficient coverage or clarity of AR images given the intended display media placement and orientation, which can compromise the level of immersion and believability that an AR system is able to provide. For example, optical clarity at the edges of an AR lens may not mimic a user's peripheral vision. A conventional AR lens may be a spherical optic having a curved surface that is generally spherical or manufactured with a constant radius of curvature. Spherical optics are unable to provide both the desired field of view and minimization of harsh screen edges. Further, spherical optics of the size needed for a field of view to permit viewing within an amusement park attraction would be either out of focus or too close to a user's face, or an AR environment, with a wide range of guests. Therefore, updates to optical media for use in an AR environment that minimize harsh edges and improve field of view are needed.

The disclosed embodiments provide an optical reflective surface (e.g. a reflective lens) that is more complex than traditional spherical optics, yet has parametric definition that freeform optics lack. Freeform optics may refer to a type of optical component that is designed with little to no symmetry, while conventional spherical optics may have a constant radius of curvature across the entire curved surface of the lens. In contrast, the disclosed embodiments provide an optic (e.g. a reflective lens) that is neither fully spherical nor fully freeform. Rather, the disclosed embodiments provide an optic created by defining a single radius for one plane and one or more varying radii along a curve for an intersecting plane. The varying radius is used to create a larger radius in a middle region of the optic that provides focal clarity and allows the optic to be further from the face (e.g., for improved fitting and comfort), while two or more smaller radii are provided on an inner region and on an outer region of the optic closer to where the user's eyes converge and the user's peripheral vision, respectively. This change in radius (e.g. small to large to small) across the field of view allows for full field of view coverage and elimination of harsh media borders. The progressive curve is swept along a static radius to create the profile of the reflective optic. In this way, the optic described herein provides improved field of view, clarity, and convergence over fully spherical optics, while also being simpler to define and iterate compared to a fully freeform optic.

In particular, the optic disclosed herein provides a more feasible solution than fully freeform optics in terms of the amount of work and the development, mapping, and digital reconstruction of a proper reflected image for a head-mounted AR device. For example, the optic disclosed herein provides a close-to-face design that provides a wide field of view. This differs from existing optics, which do not provide sufficient coverage and clarity of the reflected image given the intended display media placement and orientation. That is, simple spherical optics of the size needed for use in optical media are unable to provide both the desired field of view as well as the minimization of harsh screen edges. The optic disclosed herein, however, provides the intended field of view that is neither out of focus, nor too close to the face, and may be used in an attraction with a wide range of guests.

While certain embodiments of the disclosure may discuss two or more varying radii along a horizontal plane, the process could alternatively involve the use of any number of variable radius curves and/or curves of individual radii to achieve a similar result. Further, embodiments of the disclosure should not be interpreted as being limited to vertical and horizontal planes. Nor should the process be limited such that the vertical plane is the fixed plane. For example, in one embodiment, the fixed plane may be the horizontal plane. Additionally, it should be noted that, although the present embodiments are related to a lens for use on a head-mounted device, the reflective lens described herein may be used in other contexts. For example, the lens may be mounted to a ride vehicle, an object in a themed environment, or a land interactive. As such, it should be understood that the disclosed variable curvature reflective lens may be implemented using different combinations of the variable curvatures discussed herein in certain embodiments.

It should also be understood that the images to be generated, transmitted, and displayed may include data that is transmitted continuously (i.e. streamed) to the head-mounted devices. The data transmission is herein discussed in the context of one or more images, but these images may be continuously transmitted as video data or data of other sizes or forms (e.g. datasets, packets, and so forth), and the transmitted data may represent only a subset of the data used for the entirety of the ride experience. The images represented by the data may also be referred to in the context of AR graphics generation as frames, and the terms may herein be used interchangeably.

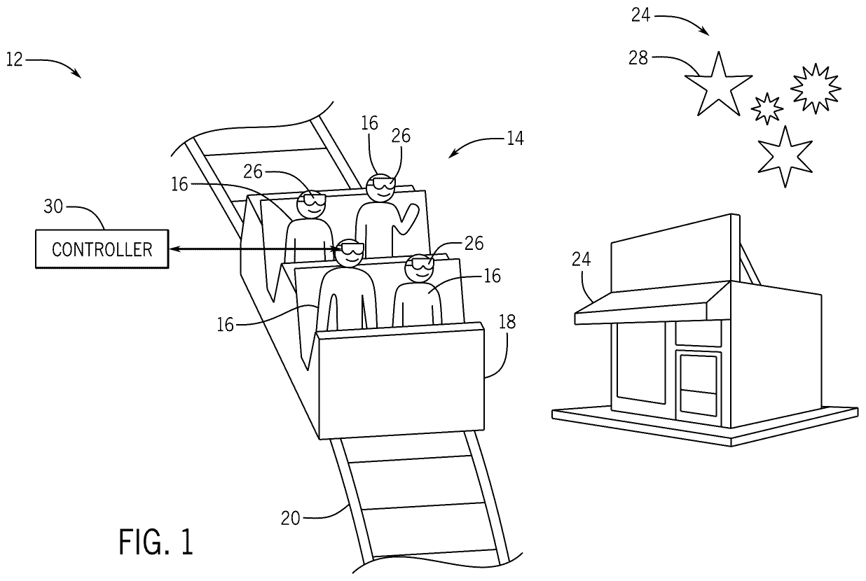

FIG. 1 is a representation of a system 12 for an amusement ride or attraction 14. The system includes head-mounted devices 26, one or more ride vehicles 18, and a controller 30. As discussed in more detail below with respect to FIG. 7, the controller 30 may be communicatively coupled to the head-mounted device 26 and/or the ride vehicle 18 via wired (e.g. HDMI, USB, etc.) or wireless connection.

The amusement ride 14 may include a ride vehicle 18 that travels along a ride path 20 and, in some cases, according to a particular motion pattern caused by vehicle motion or vehicle effects. As shown in FIG. 1, guests 16 may be positioned or seated within the ride vehicle 18 and each guest 16 has an associated head-mounted device 26 that displays images via an electronic display and a reflective lens. In some embodiments, the head-mounted device 26 may provide accompanying audio content to enhance the attraction experience. The head-mounted devices 26 may be configured for AR implementation in which, during certain times of the ride (i.e. at certain locations along the ride path 20), the guests 16 may be able to view physical structures 24 in the real-world environment through the reflective lens of the head-mounted devices 26 as well as displayed virtual features 28. In some embodiments, each guest 16 may be presented with different virtual features 28 so that each guest 16 has a different experience on the ride 14.

To provide an improved immersive experience via the head-mounted devices 26, media content, such as still images and/or streaming video, can be rendered based on data indicative of the location, position, or orientation of a guest 16 and/or the ride vehicle 18 along the ride path 20. Accordingly, as the guest 16 moves or reacts to the physical structures 24 in the real-world environment, the media content may be transmitted and displayed based on the guest's head position and/or the location of the ride vehicle 18.

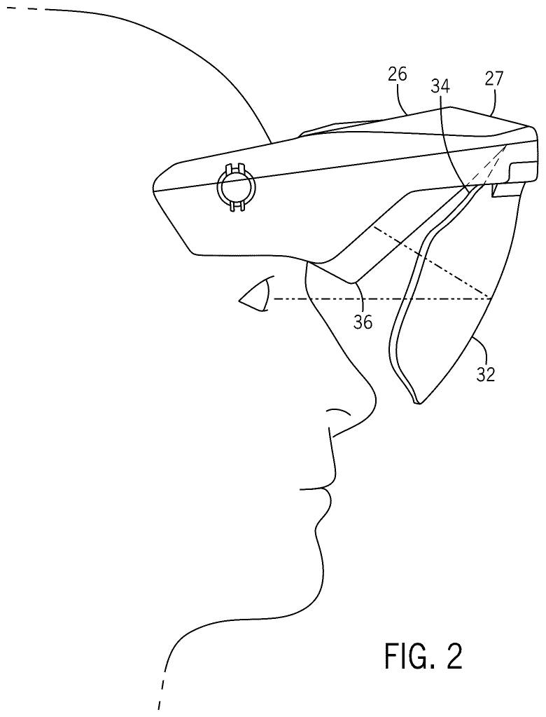

As shown in FIG. 2, the head-mounted device 26 may be configured to be worn on the head of a guest. The head-mounted device 26 may include a housing 27 (e.g., glasses, goggles, visor) configured to be placed on the head. In some embodiments, the head-mounted device 26 may include one or more sensors in, or coupled to, the device 26 and configured to track the location of the ride vehicle and/or the position or orientation of the guest's head. Additionally, the head-mounted device 26 may include a display 36 and a reflective lens 32. The display 36 may be an electronic display configured to display one or more images related to an AR environment. For example, in an embodiment, the display may be instructed to display one or more images based on a location of a ride vehicle in an AR amusement ride. Although not shown in FIG. 2, the head-mounted device 26 may receive input of a guest's location via one or more sensors on the head-mounted device 26, the ride vehicle, the AR environment, or a combination thereof. The display 36 may be any type of electronic display or screen such as, for example, an LED, OLED, LCD, or QLED display. The reflective lens 32 may be configured to reflect the one or more images from the display 36 towards the user as part of operation of the head-mounted device 26. This may be achieved, for example, via a reflective coating or other material forming the surface of the reflective lens 32 of the side that faces the eyes of the guest. As the display 36 displays the one or more images, the reflective surface of the reflective lens 32 may reflect the one or more images into the field of view of the guest. The reflective lens 32 may be spaced apart from the display 36 and tilted at an angle relative to the display 36. As illustrated by the embodiment depicted in FIG. 2, the angle 34 at which the reflective lens 32 may be tilted relative to the display 36 may be an acute angle; however, in one or more different embodiments, other angles (e.g. right or obtuse) may be implemented. In this way, the reflective lens 32 does not sit too close to the face of the guest, thereby improving the head-mounted device 26 for use in an AR attraction with a wide range of guests. The disclosed embodiments permit an angled relationship between the display 36 and the reflective lens 32 that is comfortable for the guest and that more accurately and realistically displays AR media.

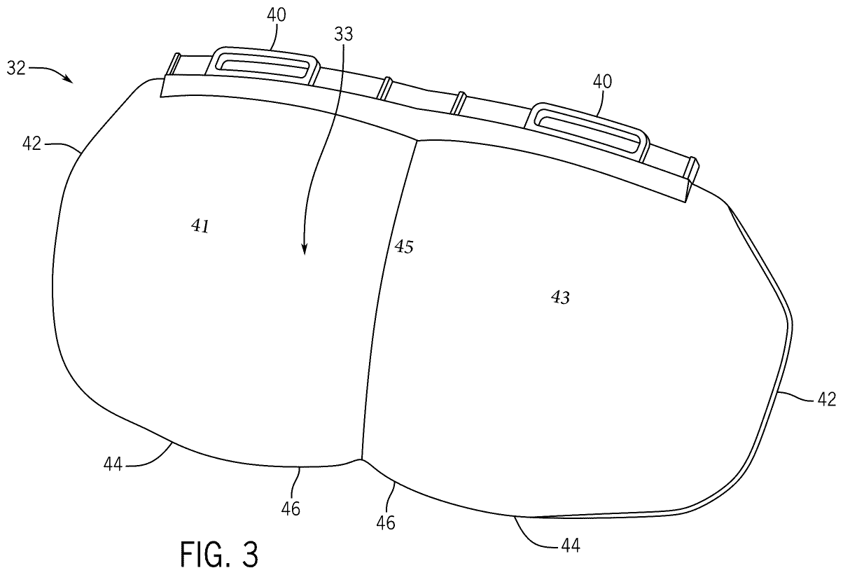

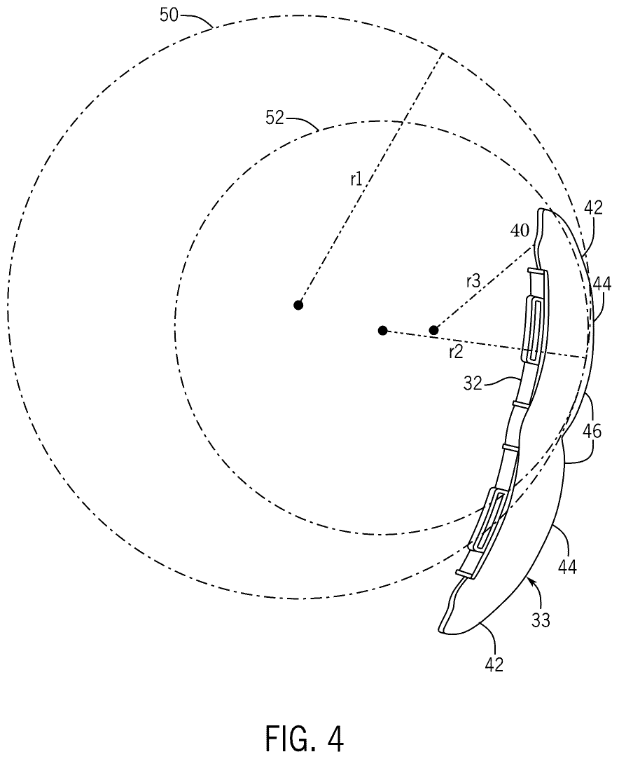

As discussed in more detail below with respective to FIGS. 3 and 4, the reflective lens 32 may have a curved or spherical surface, where the curved surface has a fixed curve in a vertical plane and a variable curve in a horizontal plane.

FIG. 3 is a schematic illustration of a front view of the reflective lens 32 (e.g. an outer surface 33 of the lens that faces the AR environment), according to one embodiment. As illustrated in FIG. 3, the reflective lens 32 may have a right eye region 41 and a left eye region 43 that converge at a middle region 45 of the lens, e.g., in a manner similar to a pair of eyeglasses, where the middle region of the lens may align with the nose of a guest when worn on the guest's head. In such an embodiment, each region (e.g. left eye and right eye) may separately include the fixed curve in the vertical plane and the variable curve in the horizontal plane. That is, both the left eye region and the right eye region may each have a curved surface with the same fixed curve in the vertical plane and the same variable curve in the horizontal plane. In certain embodiments, the lens 32 may be a unitary lens with a single viewing region (and a single fixed curve) instead of a left/right arrangement, as illustrated in FIG. 3.

Additionally, the reflective lens may have an outer region 42, a middle region 44, and an interior region 46. The outer region 42 may include an area of the reflective lens 32 that covers, at least partially, the peripheral vision of the guest when worn on the head of the guest. The middle and interior regions 46, 44 of the reflective lens 32 may include an area of the lens that covers the forward-facing field of view of the guest when worn on the guest's head. As described in more detail below with respect to FIG. 4, the curved surface of the outer and inner regions 42, 46 of the reflective lens 32 may have a smaller radius in the horizontal plane than that of the middle region 44. However, the curved surface of the outer region 42, the middle region 44, and the interior region 46 may have the same constant radius in the vertical plane.

The reflective lens 32 may be manufactured from glass, polymer, or plastic such that the reflective lens 32 is at least partially transparent (e.g., at least 50% transparent to visible light). In this way, the guest may see both the virtual images being reflected towards the guest from the display 36 (FIG. 2) as well as the real-world environment (e.g., structures 24, see FIG. 1). In other embodiments, the lens may be non-transparent or opaque. For example, in an embodiment where the lens is used as part of a vehicle ride, the lens may be a solid color. Alternatively, the lens may be a combination of transparent and non-transparent (e.g. the lens may change from transparent to solid color).

The reflective lens 32 may include one or more clips 40 configured to clip the reflective lens 32 into the housing 27 (FIG. 2) of the head-mounted device 26 (FIG. 2). For example, if the reflective lens 32 needs to be cleaned, or if the reflective lens 32 cracks or otherwise needs to be replaced, the defective lens may be detached from the head-mounted device 26 and a replacement lens may be fastened to the head-mounted device 26 in its place via the one or more clips 40. In this way, the reflective lens 32 may be clipped in and out of a head-mounted device 26 without needing to service or replace the head-mounted device 26 or the display 36.

FIG. 4 is a schematic illustration of the variable curved surface of the reflective lens 32 showing different areas with different curvature. In particular, FIG. 4 demonstrates that the curved surface of the reflective lens 32 may include the middle region 44 with a horizontal curve following a first circle 50 having a radius r1 and the outer region 42 having a horizontal curve following a second circle 52 having a radius r2. In the embodiment illustrated by FIG. 4, the radius r2 of the outer region 42 may be smaller than the radius r1. Similarly, a radius r3 of the interior region 46 may be smaller than the radius r1. The lens 32 may transition between the curvature defined by the first circle 50 (radius of curvature r1) and the curvature defined by the second circle 50 (radius of curvature r2). In this way, the variable curve of the reflective lens 32 may be a curve that varies between the middle region 44 and the outer region 42 and varies from the curve of the first circle 50 of the radius r1 to the curve of the second circle 52 of the radius r2. For example, the radius r1 of the middle region 44 may be between 100-150 millimeters, (e.g., 127 millimeters) while the radii r2 and r3 of the outer region 42 and of the interior region 46 may be between 60-120 millimeters, (e.g., 90 millimeters). The transition between these may be a transition between a curve of a circle having a radius of 127 millimeters to a curve of a circle having a radius of 90 millimeters in an embodiment. Thus, in an embodiment, the lens includes a region having a radius of curvature r1, a region having a radius of curvature r2, and a region that includes a variable radius of curvature that varies or transitions between r1 and r2. The transition may be a constant transition such that the change between r1 and r2 is at a constant rate of change or may be a variable transition.

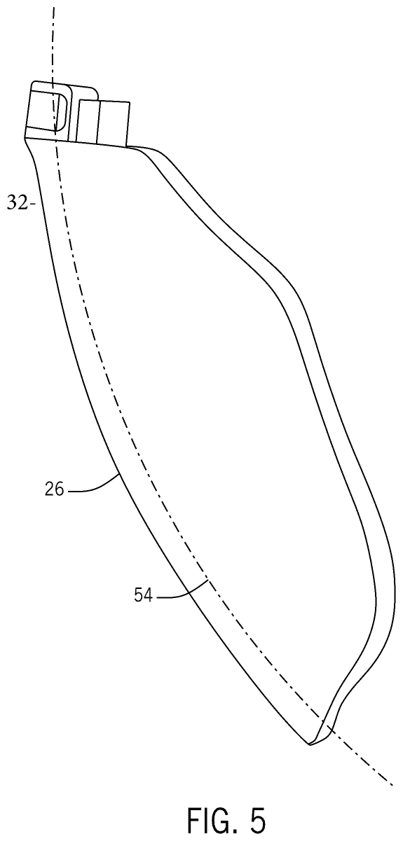

FIG. 5 is a schematic illustration of a fixed curve in the vertical plane of the reflective lens 32. The fixed curve in the vertical plane may have a radius between 90-150 millimeters, (e.g., 127 millimeters). In an embodiment, the curve in the vertical plane follows an arc 54 that, when extended with a constant radius of curvature, forms a circle. It should be noted that, in embodiments where the lens is used for an AR experience not worn on a guest's head, the vertical radius may be larger. Conversely, in an embodiment where the lens is used in an iteration where the lens is closer to a guest's face (e.g. a pair of goggles), the vertical radius may be smaller. As discussed above with respect to FIGS. 3 and 4, the reflective lens 32 may have a right eye region and a left eye region, and each region may have the same constant radius r3 in the vertical plane. Further, each of the left and right eye regions may include the variable curve described in FIG. 4, where the variable curve over each eye may include a radius r1 in a middle region 44 of the lens 32 and a radius r2 on an outer region 42 of the lens 32. Further, the second radius r2 may be smaller than the first radius r1. Additionally, the radius of the fixed curve in the vertical plane 54 may be about the same as the radius r1 (i.e. the radius of the middle region 44) (e.g., within 5% of the value of r1).

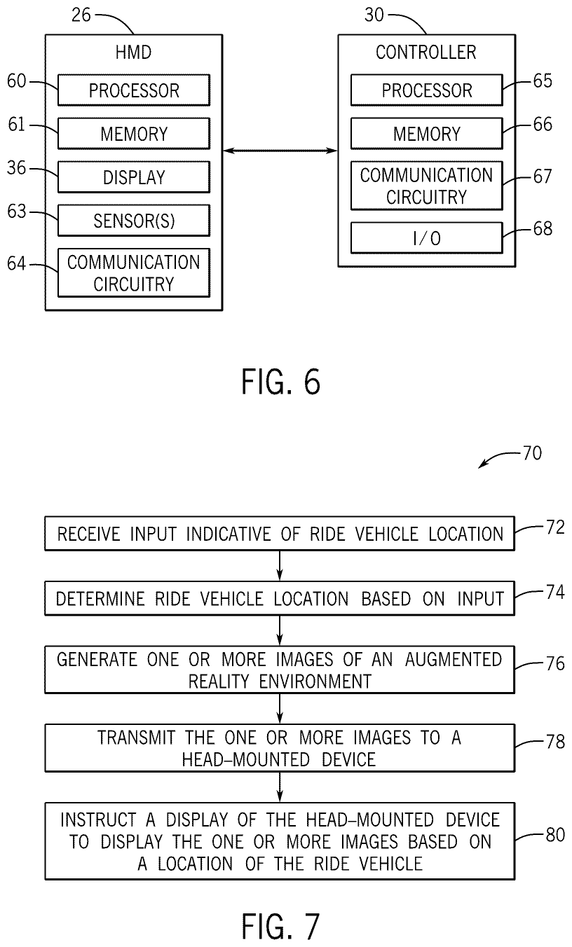

FIG. 6 is a block diagram of communication between the controller 30 and the head-mounted device 26. According to the embodiment illustrated in FIG. 6, the head-mounted device 26 may include one or more processor(s) 60, one or more memory devices(s) 61, the display 36, one or more sensor(s) 63, and communication circuitry 64. The one or more processor(s) 60 may execute software programs and/or instructions to display images to the display 36. Moreover, the processor(s) 60 may include multiple microprocessors, one or more “general-purpose” microprocessors, one or more special-purpose microprocessors, and/or one or more application specific integrated circuits (ASICs), and/or one or more reduced instruction set (RISC) processors. The memory device(s) 61 may include one or more storage devices, and may store machine-readable and/or processor-executable instructions (e.g., firmware or software) for the processor(s) 60 to execute, such as instructions relating to determining location information, displaying a virtual object, or both. As such, the memory device(s) 61 may store, for example, control software, look up tables, configuration data, and so forth, to facilitate determining the location of a ride vehicle and/or a guest, displaying a virtual object, or both. In some embodiments, the processor(s) 60 and the memory device(s) 61 may be internal or external to the head-mounted device 26. The memory device(s) 61 may include a tangible, non-transitory, machine-readable-medium, such as a volatile memory (e.g., a random access memory (RAM)) and/or a nonvolatile memory (e.g., a read-only memory (ROM), flash memory, hard drive, and/or any other suitable optical, magnetic, or solid-state storage medium).

The one or more sensors 63 may include, for example, hand-tracking sensors, eye-tracking sensors, inertial measurement units, microphones, and the like. As described in more detail below with respect to FIG. 7, the one or more sensors 63 may be configured to determine where the guest 16 is in the attraction or along the ride path 20. The guest's location may affect what image or virtual object is displayed in the virtual environment (e.g. an animation, special effect, movement).

The controller 30 may be communicatively coupled to the head-mounted device 26 and may be configured to send and receive input from the head-mounted device 26. The controller 30 may include one or more processor(s) 65, one or more memory device(s) 66, communication circuitry 67, and an input/output (I/O) port 68. The I/O port 68 may receive location information from the head-mounted device 26 and/or directly from the one or more sensor(s) 63 of the head-mounted device 26. The processor(s) 65 may execute software programs to generate or select which virtual images to display based on the location information, where the virtual images may correspond to a position or location of the ride vehicle and/or the guest, and/or the position or orientation of the guest's head. The processor(s) 65 may also execute software programs and/or instructions to generate or select a virtual image to be displayed based on the location information. The memory device(s) 66 may include one or more storage devices and may store machine-readable and/or processor-executable instructions (e.g., firmware or software) for the processor(s) 65 to execute, such as instructions relating to generating and transmitting images based on location information. The communication circuitries 64 and 67 may facilitate wireless (e.g. ethernet, WAN, and the like) and/or wired (HDMI, USB, and so forth) communication between the head-mounted device 26 and controller 30.

FIG. 7 is a flow diagram of a method 70 for displaying one or more virtual images related to an AR environment using the head-mounted device 26 as discussed with references to features of FIGS. 1-6. The process begins at block 72 with receiving input indicative of a location of a ride vehicle, a guest's orientation or position in an AR environment, and/or a position or orientation of the head-mounted device 26. For example, the location information may be generated using one or more sensors 63 on-board the head-mounted device 26, the ride vehicle 18, or both. Additionally or alternatively, the location information may be generated by environmental sensors of the attraction 14.

At block 74, the location and/or position of the ride vehicle and/or the guest may be determined. For example, the location information may be sent to the controller 30 communicatively coupled to the head-mounted device 26 to determine the location of the ride vehicle 18 and/or the guest's position or orientation in the AR environment based on the sensor input. At block 76, when the controller 30 receives the location information, the controller 30 may generate and/or select one or more images for display on the display 36 based, at least in part, on the location information. For example, the controller 30 may receive the sensor input, determine a location of the ride vehicle and, based on the location, select from the one or more memory devices 66 one or more images of one or more virtual objects to display, where the one or more images correspond to the determined location of the ride vehicle and/or the position or orientation of the head of a guest.

At block 78, the controller 30 may transmit the one or more images to the head-mounted device 26 to be displayed by the display 36 at a time point subsequent to the determination of the location such that the one or more images are displayed in sync with a sequence of events and/or visuals of the attraction or AR environment. For example, as the guest moves through the attraction, a sequence of events related to the ride may unfold. As such, a particular visual representing a particular event may correspond to a particular location of the ride vehicle along the ride path and/or a particular head position or orientation of the guest. Thus, as the guest moves through the attraction, the location information may be updated and the corresponding visual for the subsequent event may be generated and/or retrieved from memory and transmitted to the head-mounted device 26. At block 80, the controller 30 may then instruct the display to display the one or more images at the corresponding location of the ride path.

While only certain features of the invention have been illustrated and described herein, many modifications and changes will occur to those skilled in the art. It is, therefore, to be understood that the appended claims are intended to cover all such modifications and changes as fall within the true spirit of the invention.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112 (f). However, for any claims containing elements designated in any other manner, it is intended that such elements are not to be interpreted under 35 U.S.C. 112 (f).

1. A head-mounted device, comprising:
a display configured to display one or more images; and
a reflective lens spaced apart from the display and configured to reflect the one or more images towards a user, wherein the reflective lens comprises a curved surface, the curved surface having a fixed curve in a first plane and a variable curve in a second plane, wherein the variable curve comprises two or more varying radii.

2. The head-mounted device of claim 1, wherein the curved surface comprises a first region with a horizontal curve of a first radius, a second region having a horizontal curve of a second radius, and a third region having a horizontal curve of a third radius, wherein the second radius is larger than the first and third radii, and wherein the variable curve:
is between the first region, the second region, and the third region; and
wherein the variable curve varies from the first radius to the second radius to the third radius.

3. The head-mounted device of claim 1, wherein the reflective lens is tilted relative to the display.

4. The head-mounted device of claim 1, wherein the reflective lens is at least partially transparent.

5. The head-mounted device of claim 1, wherein the reflective lens comprises a right eye region and a left eye region, each having the variable curve.

6. The head-mounted device of claim 1, wherein the variable curve comprises a first radius in an interior region of the lens, a second radius in a middle region of the lens, and a third radius in an outer regions of the lens, wherein the second radius is larger than the first and third radii.

7. The head-mounted device of claim 6, wherein the first and third radii are between 90 millimeters and 127 millimeters.

8. The head-mounted device of claim 1, wherein the first plane is a vertical plane and the fixed curve has a radius of 100-150 millimeters.

9. The head-mounted device of claim 1, wherein the variable curve comprises a first radius in an interior region of the lens, a second radius in a middle region of the lens, and a third radius on an outer region of the lens, wherein the second radius is larger than the first and third radii, and wherein a radius of the fixed curve is the same as the second radius.

10. A head-mounted device method, comprising:
generating, at a server, one or more images of an augmented reality (AR) environment; and
transmitting, at the server, the one or more images to a head-mounted device, the head-mounted device comprising:
a display configured to display the one or more images; and
a reflective lens spaced apart from the display and configured to reflect the one or more images towards a user, wherein the reflective lens comprises a curved surface, the curved surface having a fixed curve in a first plane and a variable curve in a second plane.

11. The method of claim 10, wherein the head-mounted device is communicatively coupled to a controller and a ride vehicle configured to move along a ride path.

12. The method of claim 11, comprising determining a location of the ride vehicle along the ride path and instructing the display to display the one or more images based on the location of the ride vehicle.

13. The method of claim 10, wherein the reflective lens comprises a right eye region and a left eye region, each having the variable curve.

14. The method of claim 10, wherein the reflective lens is tilted relative to the display such that the reflective lens and the display form an acute angle.

15. A system, comprising:
a head-mounted device, wherein the head-mounted device comprises:
a display configured to display one or more images; and
a reflective lens spaced apart from the display and configured to reflect the one or more images towards a user, wherein the reflective lens comprises a curved surface, the curved surface having a fixed curve in a first plane and a variable curve in a second plane; and
a ride vehicle configured to move along a path; and
a controller communicatively coupled to the head-mounted device and the ride vehicle, wherein the controller is configured to:
determine a location of the ride vehicle along the path; and
instruct the display to display the one or more images based on the location of the ride vehicle.

16. The system of claim 15, wherein the curved surface comprises a first region having a horizontal curve of a first radius, a second region having a horizontal curve of a second radius, and a third region having a horizontal curve of a third radius, wherein the second radius is larger than the first and third radii, and wherein the variable curve:
is between the first region, the second region, and the third region; and
wherein the variable curve varies from the first radius to the second radius to the third radius.

17. The system of claim 16, wherein a radius of the fixed curve is in a vertical plane and is the same as the second radius.

18. The system of claim 15, wherein the reflective lens comprises a right eye region and a left eye region, each having the variable curve.

19. The system of claim 15, wherein the reflective lens is at least partially transparent.

20. The system of claim 15, wherein the reflective lens comprises a reflective coating.
